(19) United States
(12) Patent Application Publication
(10) Pub. No.: US 2016/0366895 A1
(43) Pub. Date: Dec. 22, 2016

(54) Uniform Dough Rolling System

(71) Applicant: Robert Copen, Copley, OH (US)

(72) Inventor: Robert Copen, Copley, OH (US)

(21) Appl. No.: 14/743,233

(22) Filed: Jun. 18, 2015

(51) Int. Cl. A21C 3/02

(52) U.S. Cl. CPC A21C 3/025

(57) ABSTRACT

A uniform dough rolling system includes a plurality of guides for positioning a rolling pin thereupon to space the rolling pin from a rolling surface. The plurality of guides including a first set of guides and a second set of guides, wherein at least one of the guides of the first set is positioned on one side of dough to be rolled and at least one of the guides of the second set is positioned on another side of the dough to be rolled. The guides of the first set are stackable on top of each other and the guides of the second set are stackable on top of each other such that a height from the rolling surface to an upper surface of an uppermost one of the guides is alterable. A plurality of couplers releasably holds together stacked ones of the guides.

### BACKGROUND OF THE DISCLOSURE

### Field of the Disclosure

The disclosure relates to dough rolling assisting devices and more particularly pertains to a new dough rolling assisting device for ensuring dough rolled out by a rolling pin has a uniform, pre-selected thickness.

### SUMMARY OF THE DISCLOSURE

An embodiment of the disclosure meets the needs presented above by generally comprising a plurality of guides configured to have a rolling pin positioned thereupon such that the rolling pin is spaced from a rolling surface when the rolling pin is positioned on and extended between a pair of the guides. Each of the guides is elongated and has a first end, a second end, an upper surface, a lower surface, an inner edge and an outer edge. The plurality of guides including a first set of guides and a second set of guides, wherein at least one of the guides of the first set is configured to be positioned on one side of dough to be rolled and at least one of the guides of said second set is to be positioned on another side of the dough to be rolled. The guides of the first set are stackable on top of each other and the guides of the second set are stackable on top of each other such that a height from the rolling surface to an upper surface of an uppermost one of the guides is alterable. A plurality of couplers releasably holds together stacked ones of the guides.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a uniform dough rolling system according to an embodiment of the disclosure.

FIG. 2 is a front view of an embodiment of the disclosure.

FIG. 3 is a front view of an embodiment of the disclosure.

FIG. 4 is a top view of an embodiment of the disclosure.

FIG. 5 is a perspective in-use view of an embodiment of the disclosure.

### DESCRIPTION OF THE PREFERRED EMBODIMENT

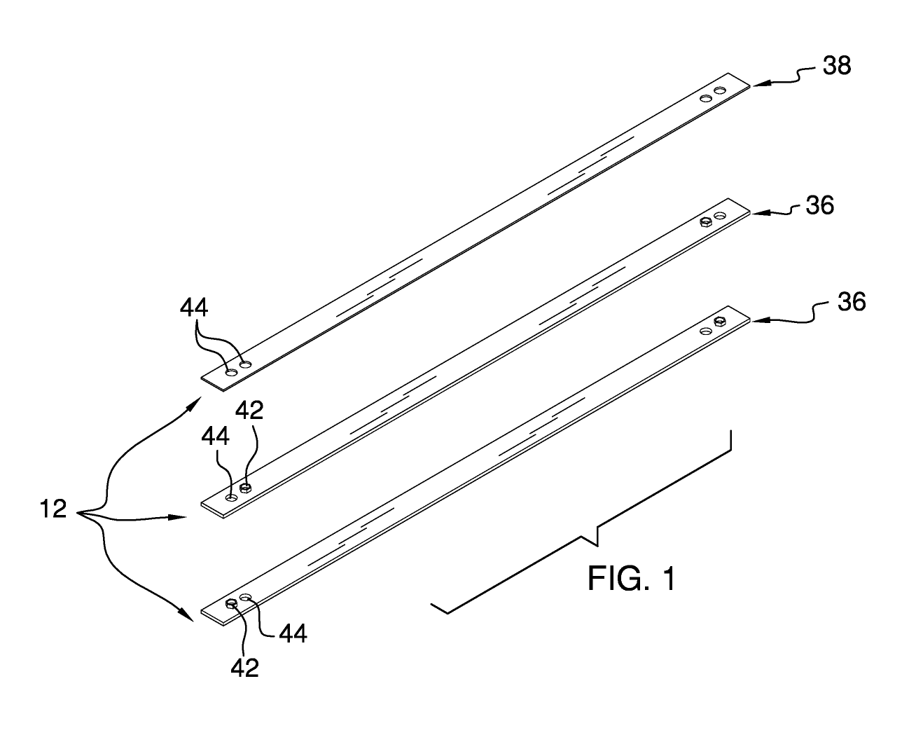

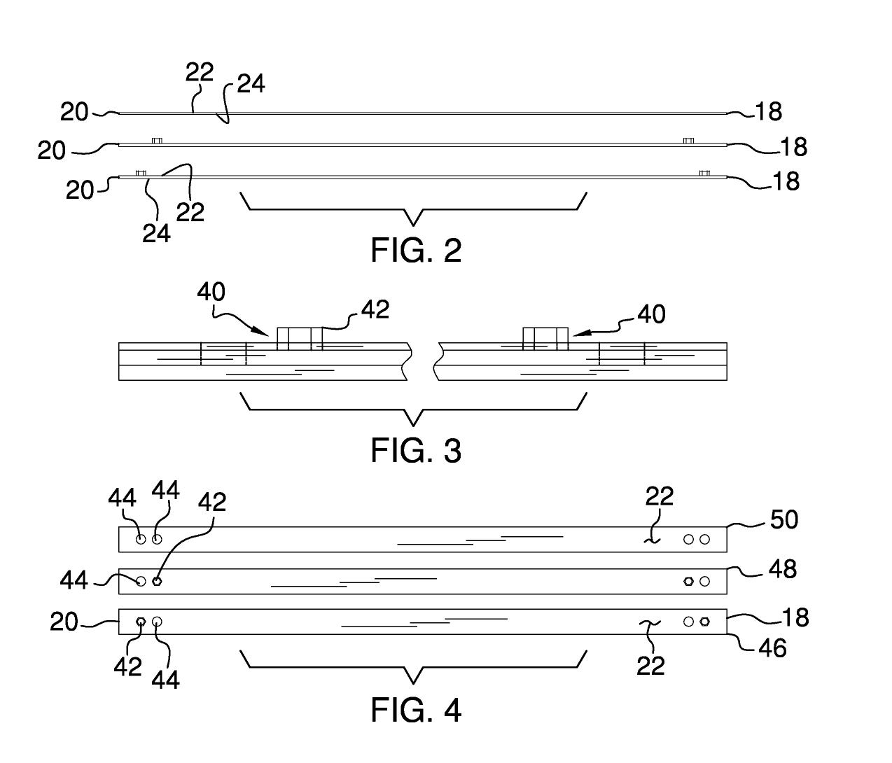

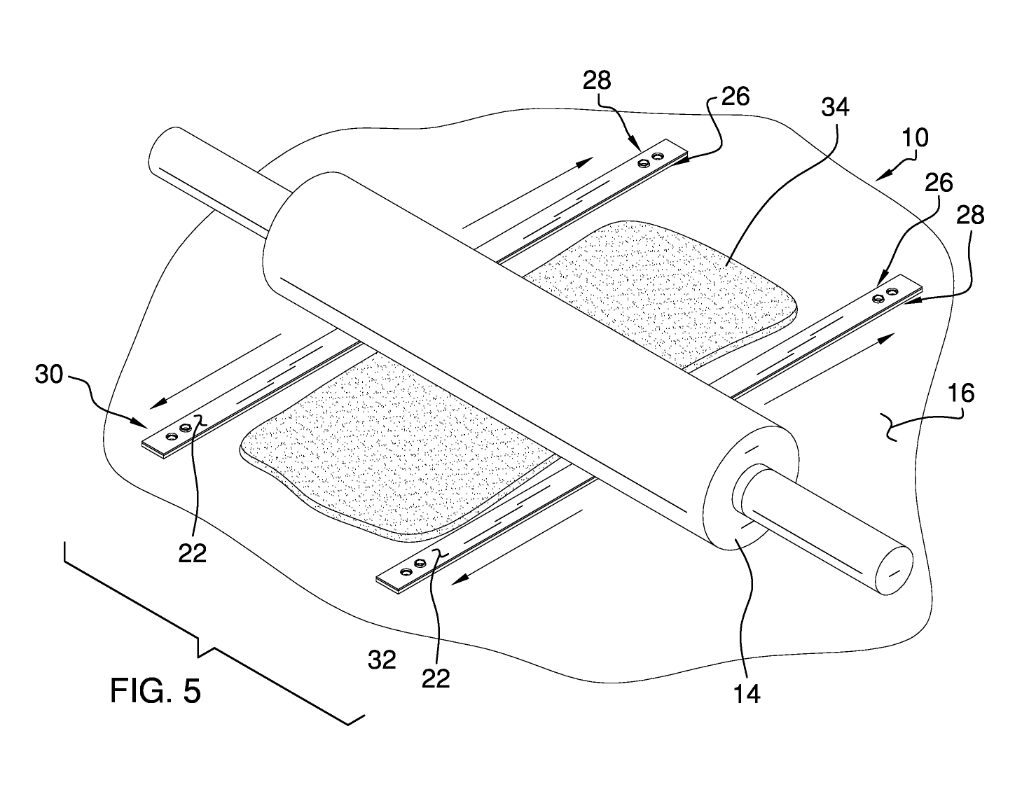

With reference now to the drawings, and in particular to FIGS. 1 through 5 thereof, a new dough rolling assisting device embodying the principles and concepts of an embodiment of the disclosure and generally designated by the reference numeral 10 will be described.

As best illustrated in FIGS. 1 through 5, the uniform dough rolling system 10 generally comprises a plurality of guides 12 configured to have a rolling pin 14 positioned thereupon such that the rolling pin 14 is spaced from a rolling surface 16 when the rolling pin 14 is positioned on and extended between a pair of the guides 12. Each of the guides 12 is elongated and has a first end 18, a second end 20, an upper surface 22, a lower surface 24, an inner edge 26 and an outer edge 28. Each of the guides 12 is substantially straight from the first end 18 to an associated second end 20. The guides 12 may each have a length between 18.0 inches and 30.0 inches and a width between 1.0 inches and 3.0 inches. Furthermore, each of the guides 12 has a height from the lower surface 24 to the upper surface 22 between 0.05 inches and 0.25 inches. The guides 12 may be comprised of any substantially rigid material including plastics, wood and metals.

The plurality of guides 12 includes a first set 30 of guides 12 and a second set 32 of guides 12 such that at least one of the guides 12 of the first set 30 is configured to be positioned on one side of dough 34 to be rolled and at least one of the guides 12 of said second set 32 is to be positioned on another side of the dough 34 to be rolled. The guides 12 of the first set 30 are stackable on top of each other and the guides 12 of the second set 32 are stackable on top of each other such that a height from the rolling surface 16 to an upper surface 22 of an uppermost one of the guides 12 of each first 30 and second 32 set is alterable. Thus, the user of the system 10 may determine what a desired thickness of the dough 34 should be after it is rolled and will stack the guides 12 such that they generally match that height. The first 30 and second 32 sets each include at least one guide 12 where the height is greater than 0.10 inches and at least one guide 12 where the height is less than 0.08 inches. These guides 12 define, relatively, large supports 36 and small supports 38, respectively. Each of the first 30 and second 32 sets may further include at least three guides 12 wherein each of the first 30 and second 32 sets includes at least two guides 12 having the height be greater than 0.10 inches. More particularly, the small supports 38 may have a height being equal to about 0.0625 inches and the large supports 36 may have a height being equal to about 0.125 inches.

A plurality of couplers 40 releasably holds together stacked ones of the guides 12. The couplers 40 each include a male mating member 42 and a female mating member 44. Each of the first 30 and second 32 sets includes a first one 46 of the guides 12 having a pair of male mating members 42 attached thereto. Each of the first 30 and second 32 sets includes a second one 48 of the guides 12 including a female mating member 44 and a third one 50 of the guides 12 including a female mating member 44. Additionally, the second one 48 of the guides 12 of each of the first 30 and second 32 sets may also include a male member 42 offset from the male members 42 of the first ones 46 of the guides 12, while the first ones 46 of the guides 12 may also include female mating members 44. This will allow a user of the system 10 to interconnect the guides 12 as desired. The third ones 50 of the guides 12 may comprise a small support 38 while the remaining guides 12 of each of the first 30 and second 32 sets may comprise large supports 36.

In use, the user of the system 10 will first determine what the desired thickness of the dough 34 should be when the user is finished rolling the dough 34 with a standard rolling pin 14. The guides 12 are stackable, which will allow for a wide range of thicknesses, and the user stacks the appropriate number of guides 12 for the desired thickness. The user places the dough 34 between the first 30 and second 32 sets (or a single guide from each) as shown in FIG. 5 and begins to roll the dough in a conventional manner. When the user's rolling pin 14 abuts the upper surfaces 22 of the guides 12 along their entire length the user will know that the dough 34 is at the proper thickness and this thickness will be uniform. The couplers 40 prevent the guides 12 from slipping relative to each other during the rolling process.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dough thickness control system configured to facilitate uniform thickness of dough being rolled by a rolling pin, said system comprising:
a plurality of guides configured to have a rolling pin positioned thereupon such that the rolling pin is spaced from a rolling surface when the rolling pin is positioned on and extended between a pair of said guides, each of said guides being elongated and having a first end, a second end, an upper surface, a lower surface, an inner edge and an outer edge;
said plurality of guides including a first set of guides and a second set of guides, wherein at least one of said guides of said first set is configured to be positioned on one side of dough to be rolled and at least one of said guides of said second set is to be positioned on another side of the dough to be rolled;
said guides of said first set being stackable on top of each other and said guides of said second set being stackable on top of each other such that a height from the rolling surface to an upper surface of an uppermost one of said guides is alterable; and
a plurality of couplers releasably holding together stacked ones of said guides.

2. The dough thickness control system according to claim 1, wherein each of said guides has a length between 18.0 inches and 30.0 inches and a width between 1.0 inches and 3.0 inches.

3. The dough thickness control system according to claim 1, wherein each of said guides having a height from said lower surface to said upper surface between 0.05 inches and 0.25 inches.

4. The dough thickness control system according to claim 3, wherein said first and second sets each include at least one guide having said height being greater than 0.10 inches and at least one guide having said height being less than 0.08 inches.

5. The dough thickness control system according to claim 4, wherein each of said first and second sets includes at least three guides.

6. The dough thickness control system according to claim 4, wherein each of said first and second sets including at least two guides having said height being greater than 0.10 inches.

7. The dough thickness control system according to claim 1, wherein said couplers each include a male mating member and a female mating member, each of said first and second sets including a first one of said guides having a pair of male mating members attached thereto, each of said first and second sets including a second one of said guides including a female mating member.

8. The dough thickness control system according to claim 7, wherein each of said first and second sets includes a third one of said guides including a female mating member.

9. The dough thickness control system according to claim 4, wherein said couplers each include a male mating member and a female mating member, each of said first and second sets including a first one of said guides having a pair of male mating members attached thereto, each of said first and second sets including a second one of said guides including a female mating member.

10. The dough thickness control system according to claim 9, wherein each of said first and second sets includes a third one of said guides including a female mating member.

11. A dough thickness control system configured to facilitate uniform thickness of dough being rolled by a rolling pin, said system comprising:
a plurality of guides configured to have a rolling pin positioned thereupon such that the rolling pin is spaced from a rolling surface when the rolling pin is positioned on and extended between a pair of said guides, each of said guides being elongated and having a first end, a second end, an upper surface, a lower surface, an inner edge and an outer edge, each of said guides being substantially straight from said first end to an associated second end, each of said guides having a length between 18.0 inches and 30.0 inches and a width between 1.0 inches and 3.0 inches, each of said guides having a height from said lower surface to said upper surface between 0.05 inches and 0.25 inches;
said plurality of guides including a first set of guides and a second set of guides, wherein at least one of said guides of said first set is configured to be positioned on one side of dough to be rolled and at least one of said guides of said second set is to be positioned on another side of the dough to be rolled;
said guides of said first set being stackable on top of each other and said guides of said second set being stackable on top of each other such that a height from the rolling surface to an upper surface of an uppermost one of said guides is alterable;
said first and second sets each including at least one guide having said height being greater than 0.10 inches and at least one guide having said height being less than 0.08 inches, each of said first and second sets including at least three guides, each of said first and second sets including at least two guides having said height being greater than 0.10 inches; and
a plurality of couplers releasably holding together stacked ones of said guides, said couplers each including a male mating member and a female mating member, each of said first and second sets including a first one of said guides having a pair of male mating members attached thereto, each of said first and second sets including a second one of said guides including a female mating member, each of said first and second sets including a third one of said guides including a female mating member.
